(19) United States
(12) Patent Application Publication
(10) Pub. No.: US 2021/0383602 A1
(43) Pub. Date: Dec. 9, 2021

(54) SYSTEMS AND METHODS FOR VISUALIZING WORKPLACE LAYOUT SAFETY

(71) Applicant: FASTOFFICE CORP., Toronto (CA)

(72) Inventors: Colin Eric GRAHAM, Toronto (CA); Sasidharan VADAKKEPAT, Chennai (IN); Sijia SONG, Toronto (CA)

(21) Appl. No.: 17/339,351

(22) Filed: Jun. 4, 2021

Related U.S. Application Data
(60) Provisional application No. 63/054,537, filed on Jul. 21, 2020.

(30) Foreign Application Priority Data
Jun. 6, 2020 (IN) 202011023847

(51) Int. Cl. G06T 17/05; G06T 19/00; G06T 15/20; G08B 21/18

(52) U.S. Cl. CPC G06T 17/05; G06T 19/003; G06T 2215/16; G08B 21/182; G06T 2219/012; G06T 15/20

(57) ABSTRACT

Disclosed are systems and methods for visualizing workplace layout safety. A data structure of a workplace layout is processed to identify workplace objects and determine their respective locations. Likely locations of individuals are determined, corresponding to locations of the workplace objects. Safety parameters indicative of a required minimum separation between individuals are received, and a 3D model representation of the workplace layout is generated with a plurality of safety zones, each of the safety zones having a location corresponding to one of the likely locations of individuals in the workplace layout, and having a size corresponding to the safety parameter. Interference between at least two of the safety zones is determined, and a visual representation of the workplace layout is generated using the 3D model representation with a first visual indicator indicative of the safety zones, and a second visual indicator indicative of the determined interference between safety zones.

### CROSS-REFERENCE TO RELATED APPLICATIONS

This application claims all benefit including priority to Indian Provisional Patent Application No. 202011023847, filed Jun. 6, 2020 and U.S. Provisional Patent Application No. 63/054,537, filed Jul. 21, 2020, each entitled “SYSTEMS AND METHODS FOR VISUALIZING WORKPLACE LAYOUT SAFETY”, the entire contents of each of which are hereby incorporated by reference herein.

### FIELD

This disclosure relates to generating visual models, and more particularly relates to generating visual models to visualize workplace layout safety.

### BACKGROUND

Designing workplace layouts to prevent occupant or individual injury, whether resulting from harmful biological agents spreading or otherwise, is a multi-variant problem which needs to account for subjective factors which are difficult to model.

Moreover, regulatory requirements may vary between jurisdictions, the regulatory requirements themselves may vary within a jurisdiction over time, and the nature of the work performed in the workplace may change over time, complicating planning for, and adjusting for, the multiple variables and subjective factors for designing workplace layouts.

Accordingly, there is need for improved visual models to visualize workplace layout safety.

### SUMMARY

In accordance with an aspect, there is provided a computer-implemented method for visualizing workplace layout safety. The method includes receiving a data structure including data representative of a workplace layout and processing the data structure to identify a plurality workplace objects and determine respective locations of the workplace objects. A plurality of likely locations of individuals are determined in the workplace layout, with each of the likely locations corresponding to one of the locations of the workplace objects. Safety parameters indicative of a required minimum separation between individuals are received, and a 3D model representation of the workplace layout is generated. Generating the 3D model representation includes populating the 3D model representation with a plurality of 3D object models, each of the object models representative of one of the workplace objects, and populating the 3D model representation with a plurality of safety zones, each of the safety zones having a location corresponding to one of the likely locations of individuals in the workplace layout, and having a size corresponding to the safety parameter. Interference between at least two of the safety zones is determined, and a visual representation of the workplace layout is generated using the 3D model representation with a first visual indicator indicative of the safety zones, and a second visual indicator indicative of the determined interference between safety zones.

In accordance with another aspect, there is provided a computer-implemented system for visualizing workplace layout safety. The system includes: at least one processor; memory in communication with the at least one processor; and software code stored in the memory. The software code when executed at the at least one processor causes the system to: receive a data structure including data representative of a workplace layout and process the data structure to identify a plurality workplace objects and determine respective locations of the workplace objects. The system further determines a plurality of likely locations of individuals in the workplace layout, each of the likely locations corresponding to one of the locations of the workplace objects, and receives a safety parameter indicative of a required minimum separation between individuals. The system further generates a 3D model representation of the workplace layout by populating the 3D model representation with a plurality of 3D object models, each of the object models representative of one of the workplace objects, and by populating the 3D model representation with a plurality of safety zones, each of the safety zones having a location corresponding to one of the likely locations of individuals in the workplace layout, and having a size corresponding to the safety parameter. The system also determines interference between at least two of the safety zones, and generates a visual representation of the workplace layout using the 3D model representation, the visual representation including a first visual indicator indicative of the safety zones, and a second visual indicator indicative of the determined interference between safety zones.

In accordance with a further aspect, there is provided a non-transitory computer readable tangible storage medium, which when executed by a processor, cause the processor to perform the preceding methods.

Many further features and combinations thereof concerning embodiments described herein will appear to those skilled in the art following a reading of the instant disclosure.

### BRIEF DESCRIPTION OF THE DRAWINGS

Embodiments will be described, by way of example only, with reference to the attached figures, wherein in the figures:

FIG. 1 is a network diagram of a system for visualizing workplace layout safety, in accordance with an embodiment;

FIG. 2 is a schematic diagram of the system for visualizing workplace layout safety of FIG. 1, in accordance with an embodiment;

FIG. 3 is a visual representation of an example data structure, in accordance with an embodiment;

FIG. 4A shows an example visual representation including an interactive panel for adjusting safety parameters of the example data structure, in accordance with an embodiment;

FIGS. 4B and 4C each show an example 3D visual representation of the example data structure, in accordance with an embodiment;

FIGS. 5A to 5C show example 3D visual representations of the example data structure having safety zones, in accordance with an embodiment;

FIGS. 6A and 6B each show a 3D visual representation having at least two safety zones which display interference, in accordance with an embodiment;

FIGS. 7A and 7B each show a 3D visual representation having at least two safety zones which do not display interference, in accordance with an embodiment;

FIGS. 8A and 8B is a sequence of diagrams of a 3D visual representation with at least two safety zones at first not displaying interference in FIG. 8A, and upon updating displaying interference in FIG. 8B, in accordance with an embodiment;

FIG. 8C shows a 3D representation of safety zones modified by mitigating workplace objects, in accordance with an embodiment;

FIG. 9 is a flowchart of an example of method for visualizing workplace layout safety, in accordance with some embodiments; and

FIG. 10 is a schematic diagram for a computing device, in accordance with an embodiment.

These drawings depict exemplary embodiments for illustrative purposes, and variations, alternative configurations, alternative components and modifications may be made to these exemplary embodiments.

### DETAILED DESCRIPTION

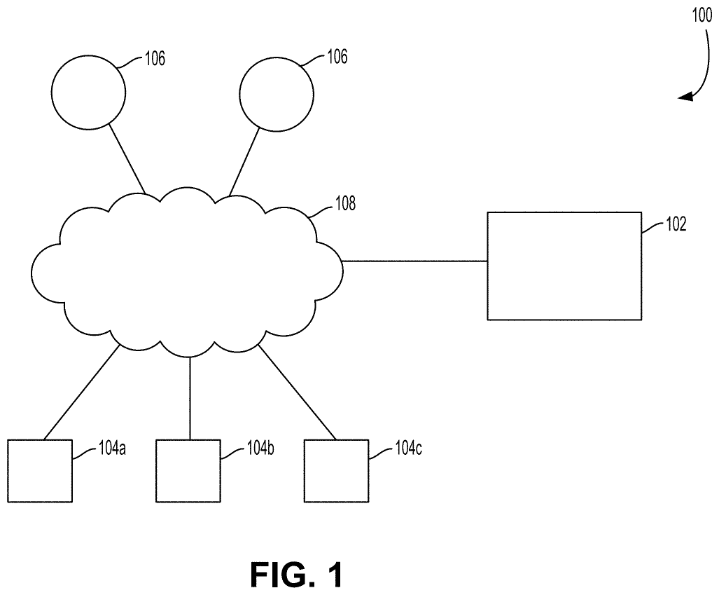

FIG. 1 is a network diagram for an example computer-implemented system 100 for visualizing workplace layouts, in accordance with an embodiment.

In example embodiments, the system 100 includes a server 102 for generating visualizing workplace layouts. Server 102 serves visualized workplace layouts for viewing by end users, for example, users operating client devices 104. The visualized workplace layouts can include 2D workplace layouts, 3D workplace layouts, and workplace layouts having a variety of features as described herein.

In example embodiments, the system 100 serves information derived from or associated with visualized workplace layouts for consumption by end users. For example, the server 102 may generate alerts indicating potentially unsafe environments within a workplace layout, or may generate suggestions or templates to assist in designing workplace layouts. In example non-limiting embodiments, the system 100 may provide a communication interface for a workplace layout consultant, working at the server 102, to connect to and interact with the workplace layout served to the end user. Such communication interface may provide at least partial remote control or interaction by the server 102 with the client device 104a by a user of the server 102.

The server 102 is interconnected with a plurality of data sources 106 by way of a communication network 108.

The data sources 106 can store or maintain one or more data objects reflective of computer models which can be used to visualize workplace layouts. The data sources 106 may, for example, be operated by third parties who provide services to workplaces, such as furniture manufacturers. The data sources 106 may be operated by a third party who aggregates models from various sources, such as a retailer.

The data sources 106 can store or maintain one or more safety parameters which can be used to visualize workplace layouts. Such data sources 106 may, for example, be operated by third parties who provide safety parameters associated with workplace objects, such as furniture manufacturers. The data sources 106 may be operated by a third party who aggregates safety parameters, such as a health agency, public safety regulator, or other governmental or quasi-governmental agency.

System 100 may include any number of data sources 106. In some embodiments, for example, data obtained from one or more of the data sources 106 are maintained in one or more electronic databases at server 102, e.g., in a memory of server 102.

The server 102 is further interconnected with a plurality of client devices 104a, 104b, and 104c (alternatively referred to as the plurality of client devices 104, or client devices 104) by way of the communication network 108. The plurality of client devices 104 receive the visual workplace representations, and augment, update, or otherwise interact with, or store the received visual workplace representations.

The plurality of client devices 104 may include any number of any type of devices capable of receiving information from, and providing information to, the server 102 via the communication network 108. For example, the first client device 104a may be a desktop or laptop computer, the second client device 104b may be a mobile device capable of providing location data to the server 102, and the third client device 104c may be a tablet computer.

Communication network 108 may include a packet-switched network portion, a circuit-switched network portion, or a combination thereof. Communication network 108 may include wired links, wireless links such as radio-frequency links or satellite links, or a combination thereof. Communication network 108 may include wired access points and wireless access points. Portions of communication network 108 could be, for example, an IPv4, IPv6, X.25, IPX or similar network. Portions of network 108 could be, for example, a GSM, GPRS, 3G, LTE or similar wireless networks. Communication network 108 may include or be connected to the Internet. When communication network 108 is a public network such as the public Internet, it may be secured as a virtual private network.

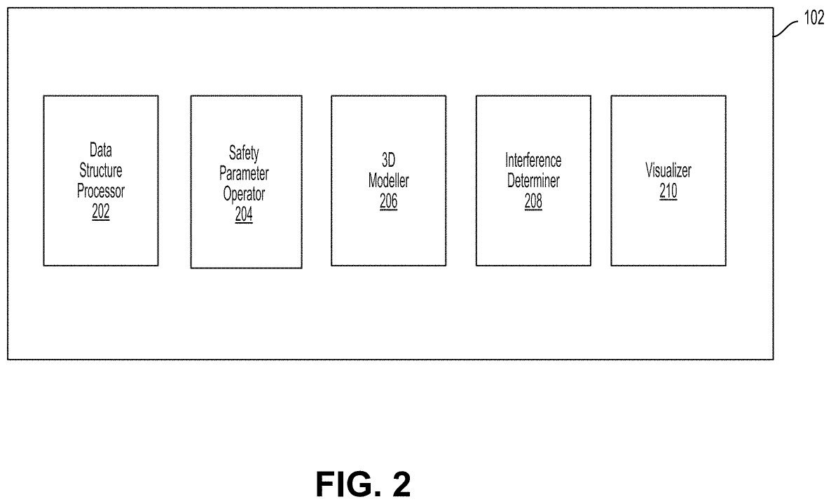

FIG. 2 is a high-level schematic diagram of server 102, in accordance with an embodiment. As depicted, server 102 includes a data structure processor 202, a safety parameter operator 204, a 3D modeller 206, an interference determiner 208, and a visualizer 210.

Data structure processor 202 can be configured to receive and process data structures including data representative of a workplace layout to identify a plurality workplace objects and determine respective locations of the workplace objects.

Receiving the data structure may include communicating, via network 108, with the client device 104 to receive the data structure representative of a workplace. In example, embodiments, receiving the data structure may include communicating with a third party, such as a municipality or a builder, to receive the data structure including data representative of a workplace layout.

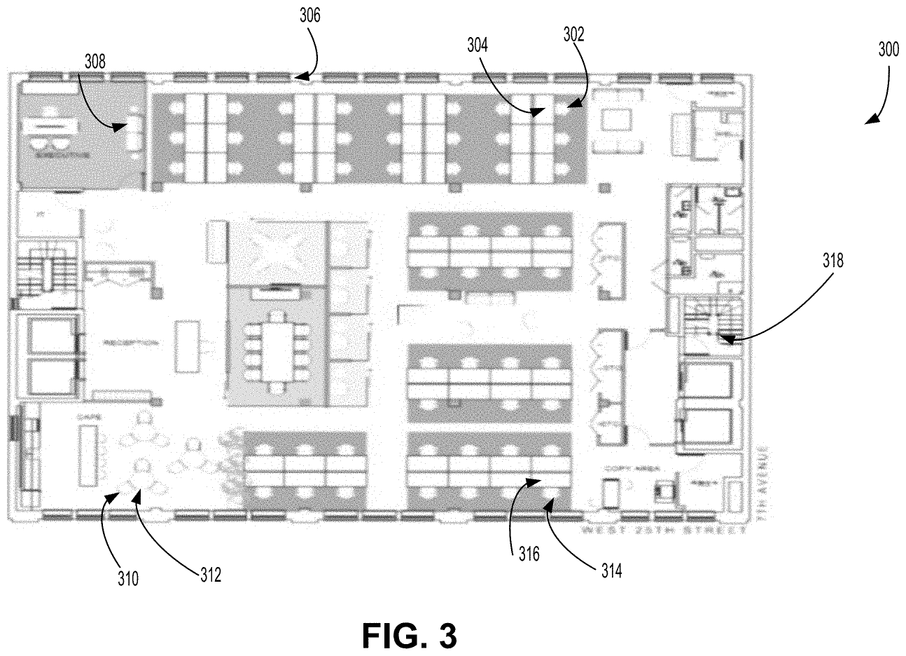

The data structure including data representative of a workplace layout may be a visual representation of the workplace layout, such as a PDF format layout of the workplace, as seen in FIG. 3. In example embodiments, the data structure including data representative of a workplace layout may be a bitmap file. In example embodiments, the data structure including data representative of a workplace layout may be a non-visual representation. In example embodiments, the data structure includes semi-structured data.

The shown data structure of FIG. 3 includes a visual representation of one or more workplace objects, including one or more seating objects 302, 308, 310, and 314 (e.g., chairs, lounges, etc.) (hereinafter referred to as seating objects), one or more working surface objects 304, 312, and 316 (e.g., desks, tables, etc.) (hereinafter referred to as surface objects), and one or more structural objects 306, 318 (e.g., walls, elevators, etc.) (hereinafter referred to as structural objects). Any number and any combination of visual representations is contemplated. For example, the visual representations for a seating object may be a square, and the visual representation for a structural object may be a shading pattern.

The data structure processor 202 processes the received the data structure and identifies a plurality workplace objects. In some embodiments, for example, the data structure processor 202 includes an artificial intelligence architecture (AIA) (not shown), which is trained on previous labelled workplace layouts to recognize shapes of workplace objects in visual representation data structures to identify the type of workplace object. For example, the AIA may be trained to recognize shapes by processing pixel data in the data structure. For example, the AIA learns based on industry standard representations of workplace objects. The AIA can include object detection and classification using convolution neural networks to identify and generate workplace objects.

In some embodiments, for example, the data structure processor 202 may be trained to identify workplace objects based on their proximity to and relation to other visual elements within the data structure. For example, the data structure processor 202 may determine that the table surface object 304 is a table as a result of determining that it is of a size or shape that is not suitable for seating. In some embodiments, the data structure processor 202 may determine that the table surface object 304 is a surface object based on the proximity and arrangement of the chair seating object 302 nearby.

According to some embodiments, the data structure processor 202 accesses the data sources 106, and compares features of the provided data structure to computer models retrieved from the data sources 106 to identify workplace objects. For example, the data structure processor 202 may access a third-party manufacturer data source 106 to determine that seating object 302 is a chair based on a comparison to the chair model stored in the manufacturer data source 106. Each workplace object may be identified according to a unique product identifier such as a SKU or similar code.

The data structure processor 202 may be configured to identify a workplace object based on the various colour elements within the image. For example, seating objects may be denoted by a colour, or zone surrounding the seating object which indicates that it is a seating object.

Similar to the processing to identify workplace objects, the data structure processor 202 may determine a location of the workplace objects.

Data structure processor 202, may, for example, as part of identifying the workplace objects, determine the respective location of the workplace objects. For example, identifying a chair seating object 302 may also include determining the location of the chair in the provided data structure. In some embodiments, identifying the workplace object includes the data structure processor 202 storing the type, and the location of the workplace object in a memory.

In some embodiments, for example, the location is determined by the data structure processor 202 independent of identifying the of workplace objects. The data structure processor 202 may scan the received data structure and identify objects as areas demarked by enclosed borders. For example, the data structure processor 202 may assign a centroid of any enclosed space, such as chair seating object 314, as having a likely location of an individual in the middle of the shape, by determining the chair as having an enclosed white area.

Any combination of identifying workplace objects and determining their locations is contemplated.

Once the data structure processor 202 identifies the workplace objects within the data structure, and determines their respective locations, the data structure processor 202 determines likely locations of individuals corresponding to the locations of the identified workplace objects.

In example embodiments, the data structure processor 202 determines likely locations of individuals based on the type of workplace object. For example, a chair seating object, such as chair seating object 302, may be determined to have a likely location of an individual in the middle of the chair. In another non-limiting example, the data structure processor 202 identifies the two seat seating object 308 and determines that there are two likely locations of individuals, one at the respective center of each seat in the two seat seating object 308.

The data structure processor 202 may also distinguish between workplace objects that are associated with likely locations of individuals and those that are not. For example, the data structure processor 202 may identify the wall structural object 306 and determine that it is an unlikely location for individuals. Similarly, the data structure processor 202 may determine that the stair structural object 318 is an unlikely location for individuals.

The server 102 processes the determined likely locations of individuals with the safety parameter operator 204 and corresponds a safety parameter indicative of a required minimum separation (i.e., the size of a safety zone) between individuals.

In example embodiments, the safety parameter is retrieved from a data sources 106. For example, the safety parameter may be retrieved by server 102 from a Center for Disease Control (CDC) data source 106, which maintains an up to date list of safety parameters for harmful biological agents. In example embodiments, the safety parameter may extracted upon parsing data from data source 106. In example embodiments, the safety parameter may be subjected to pre-processing such as normalization or unit conversion.

The server 102 may be configured to maintain an electronic database (not shown), which stores safety parameters, and retrieve the safety parameter required to generate 3D models. In a non-limiting example, the server 102 may be configured to periodically require an input to update the relevant safety parameters from authoritative data sources 106. In a further example embodiment, the server 102 may simply update the electronic database, with safety parameters through user input.

The safety parameter operator 204 may associate a safety zone having a pre-set size to each of the likely locations of individuals. For example, the safety parameter operator 204 may assign a size that is considered to a minimum distance required for safe occupation of a space within the workplace to each likely locations of individuals. In a non-limiting example, the safety parameter operator 204 may assign a size in accordance with the latest guidance from the CDC for preventing the spread of a contagion (e.g., virtual, bacterial, fungal, etc.) to each of the locations of likely locations of individuals. In one non-limiting example, the contagion is a Coronavirus.

The safety parameter operator 204 may associate varying sizes of safety zones to different likely locations of individuals.

According to example non-limiting embodiments, the safety parameter operator 204 associates sizes of safety zones based on the type of workplace object that the likely location of an individual is associated with. For example, a chair seating object 308 may include a size of a safety zone that is smaller compared to the size of a safety zone for the seating chair object 302 because it is a two seat chair, which is more prone to interaction. In a further non-limiting example, the chair seating object 312 may be corresponded a smaller size of a safety zone compared to the size of a safety zone for the seating chair object 302 as chair seating object 312 is a kitchen or dining room chair, and therefore indicative of greater movement and interaction with others.

In example embodiments, the safety parameter operator 204 associates sizes of safety zones based on the location of the workplace object that the likely location of an individual is associated with. For example, a chair seating object 308 within a small enclosed space may have a smaller size of a safety zone compared to the seating chair seating object 312 which is location in a high traffic area.

The safety parameter operator 204 may associate sizes of safety zones based on the type of likely location of an individual. For example, as described herein, in example embodiments where the likely location of an individual is determined based on updated locations (e.g., received from a user), or a real time location (i.e., received from the client device 104b), the safety parameter operator 204 may correspond larger safety zones as a result of measurement uncertainty as compared to a determined location.

The safety parameter operator 204 may associate any number of separate sizes to each of the safety zones corresponded to each likely location of individuals. Optionally, the safety parameter operator 204 may associate any number of shapes to each of the safety zones corresponded to each likely location of individuals based on the interaction between safety zones of workplace objects and mitigating objects acting on the safety zones, as described herein.

According to example embodiments, safety parameter operator 204 defines two sizes for each of the safety zones, namely an outer subzone, indicative of a safety distance based on for example harmful biological agent spread, and an inner subzone, indicative of an area the individual is likely to occupy while in the workplace layout. The inner subzone may indicate a likely space needed by the individual to work, or a likely interaction area indicative of the individuals likely movements.

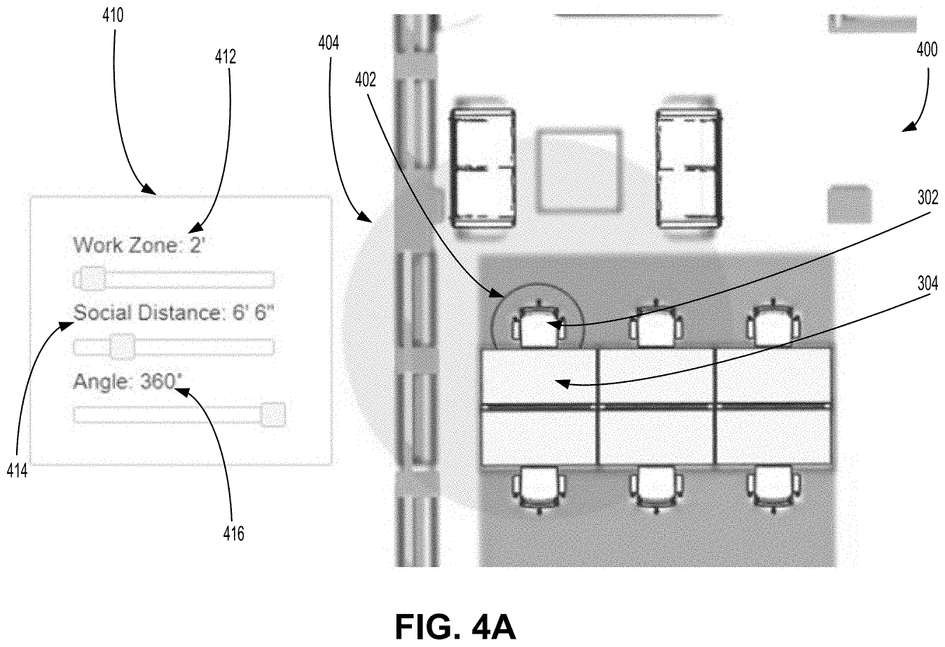

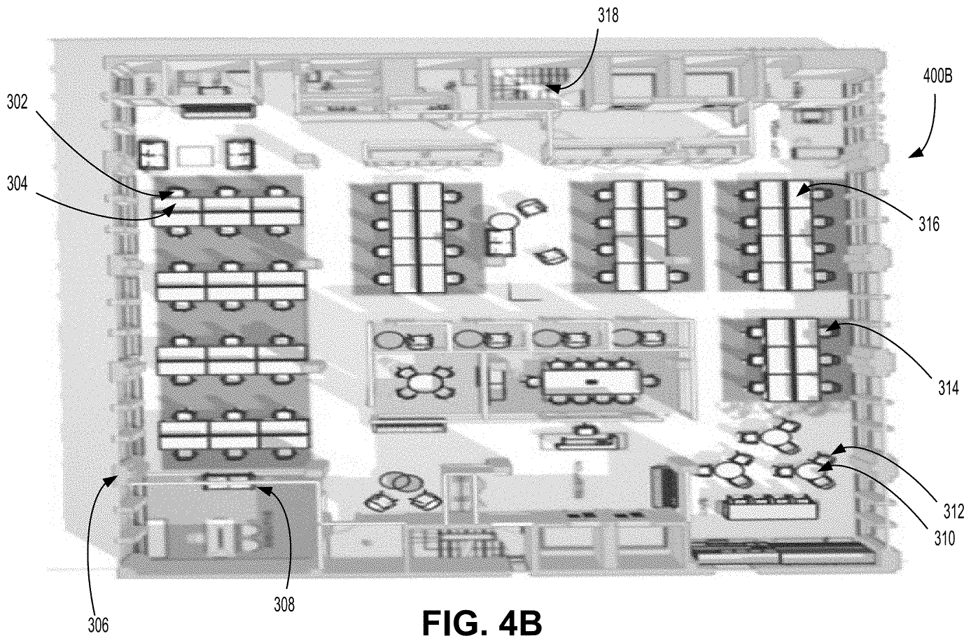

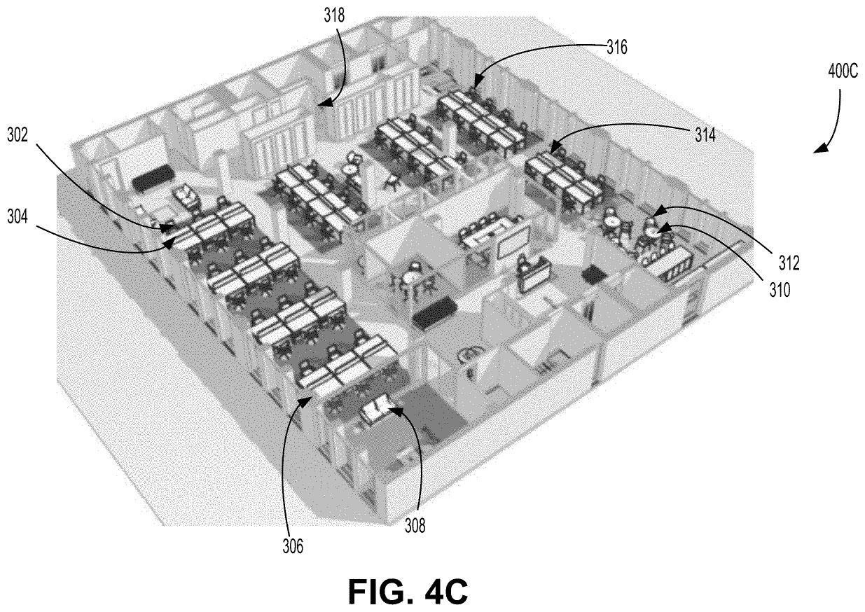

Referring now to FIG. 4A, visual representation 400 indicates an example embodiment of a visual representation of a safety zone for a likely location of an individual based on the identified chair workplace object 302, which safety zone includes a circular inner subzone 402 and a circular outer subzone 404, forming concentric circular regions. In some embodiments, the safety zone is a 3D region such that inner subzone 402 and outer subzone 404 define concentric cylindrical regions.

In the shown embodiment, the inner subzone 402, alternatively referred to as an interaction zone, is sized based on the expected space used by an individual. For example, the safety parameter operator 204 may assign a size parameter (i.e., radius) of the inner subzone 402 to be 2 feet, based on the expectation that user needs 2 feet of space to perform work while sitting in an office. In another example, the inner subzone 402 of an individual in a doctors office may represent the likely space a patient occupies while in a waiting room, for example, which may be greater due to anticipated patient movement.

In embodiments, in which the inner subzone 402 is a 3D region, the safety parameter operator 204 may assign a size parameter (i.e., a height) of the inner subzone to be 6 feet, based on expected height of a user.

The inner subzone 402, as described herein, may be based on the type of workplace object(s) associated with or near the likely location of the individual. The inner subzone 402 may be based on the size of a nearby working surface workplace object, which may be a long table requiring an individual to use increased space to utilize.

The outer subzone 404 of the safety zone may be sized based on the guidelines from authorities with respect to transmission of harmful biological agents. For example, the outer subzone 404 may be sized based on a minimum recommended distance between individuals.

FIG. 4A illustrates that in example embodiments, the inner subzone 402 (shown as “Work Zone”) and the outer subzone 404 (shown as “Social Distance”) in the visual representation 400 may be updated in response to received input. In the shown embodiment, an interactive panel 410 includes an inner subzone adjuster 412, an outer subzone adjuster 414, and an angle adjuster 416 for interacting with the visual representation of the safety zone. In example embodiments, the values of inner subzone adjuster 412 and outer subzone adjuster 414 may be pre-set. For example, the size of the inner subzone may be set to a default value. For example, the size of the outer subzone 404 may be set to a value corresponding to a safety parameter obtained or derived from data of a data source 106. In example embodiments, an alert may be generated if a user reduces the size of the outer subzone 404 to be lower than prescribed by the safety parameter.

In response to receiving input from any one of the inner subzone adjuster 412, the outer subzone adjuster 414, and the angle adjuster 416, the system 412 may update the visual representation 400 to update the safety zone. For example, input received via the inner subzone adjuster 412 will adjust the inner subzone 402 diameter in visual representation 400. In a further example, input received via the outer subzone adjuster 414 will adjust the outer subzone 404 diameter in visual representation 400. In a yet further example, input received via the angle adjuster 416 will adjust the shape of the safety zone (e.g., an angle of 180 degrees may be indicative of a half sphere safety zone). In some embodiments, the angle adjustment corresponds to the range of motion of the human head in view of a forward direction. For example, in the 2D case, instead of modeling the safety zone as a full circle angle adjuster 416 adjusts the safety zone into a shape that corresponds to the range of motion of an individual's head. This can lead to the angle adjuster 416 generating varying “bullhorn” shaped solid angles emanating from a person's face as a safety zone. In the 3D scenario, angle adjuster 416 encompasses the notion of “pitch, yaw and roll” which can leading to a solid angle that determines the region of influence of a zone.

The angle adjuster 416 can be combined with the “heading” or direction in which an individual is facing (or moving in case of dynamic zones), or the two concepts may be represented by a separate adjuster.

In example embodiments, the interactive panel 410 may include any number of features corresponding to the likely locations of individuals. For example, the interactive panel 410 may include a means of receiving input adjusting the type of workplace object identified. In a further non-limiting example, the interactive panel 410 may include a means of receiving input adjusting the likely location of the individual, such as changing a determined likely location of an individual (e.g., employees in enclosed offices typically pace, which may change their likely location).

In example embodiments, the interactive panel 410 may include a means of receiving input for selecting the jurisdiction of the workplace. This input may be used by safety parameter operator to retrieve one or more safety parameters relevant to the particular jurisdiction, e.g., from data sources 106.

The 3D modeller 206 receives the retrieved safety parameter, the determined likely location of the individual, and the identified workplace objects and the determined respective location of workplace individuals, and generates a 3D model representation of the workplace layout which includes populating the 3D model representation with 3D object models representative of each of the workplace objects.

FIGS. 4-8 show visual representations of 3D model representations generated by the 3D modeller 206, where the visual representations are generated by the visualizer 210. Hereinafter, concepts which relate to the 3D modeller 206 may be described in reference to their effect on the visual representation generated by the visualizer 210 using the generated 3D model representation.

In example embodiments, as seen in visual representations 400B and 400C in FIGS. 4B and 4C, generating the 3D model representation includes the 3D modeller 206 generating a workplace layout by populating the 3D model representation with the identified workplace objects in the determined respective workplace object locations.

The generated 3D model may be manipulated to be viewed from a variety of perspectives, including a first perspective view shown in FIG. 4B and a second perspective view shown in FIG. 4C. Any manipulation of the visual representations is possible, including any rotation, zooming in or out, and so forth.

Moreover, FIGS. 4A-4C show that the server 102 generating visual representations which do not include a visual representation of a safety zone. This particular visual representation can be useful in reviewing the aesthetic appearance of a workplace layout prior to assessing the safety of the workplace layout.

In example embodiments, in order to generate 3D object models representative of each of the workplace object, as described herein, the 3D modeller 206 retrieves 3D models of particular workplace objects from a data source 106 such as a furniture manufacturer, which may have 3D models of workplace objects. In example embodiments, the data source 106 may be a retailer or other commercial entity selling workplace objects.

Where the 3D modeller 206, or any portion of server 102 queries the data source 106 such as a furniture manufacturer, said portion of the server 102 may be configured to query for pricing data of the workplace objects.

In some embodiments, the 3D modeller 206 generates 3D object models representative of each of the workplace object based on a database of 3D object models maintained on server 102. In further example embodiments, the 3D modeller 206 may generate the 3D object models representative of each of the workplace objects based on an artificial intelligence modeller (not shown) which is trained on a database of workplace objects. For example, the artificial intelligence modeller may generate a chair model based on chairs previously encountered by the server 102.

In example embodiments, 3D model representations store the features of the workplace object which allow for visual representation of the object. In some embodiments, for example, the 3D model representations store the geometry of the object. In further example embodiments, the 3D model representations store the surfaces of the workplace object. In yet further example embodiments, the 3D model representations can store a colour, textures, material types, material properties, and so forth.

In a non-limiting example, the 3D models are stored as gITF files. Any type of 3D model storage format is contemplated.

Generating the 3D model representation further includes the 3D modeller 206 generating the workplace layout by populating the 3D model representation with a plurality of 3D safety zones, each of the 3D safety zones having a location corresponding to the determined one of the likely locations of individuals in the workplace layout, and having a size corresponding to the safety parameter. The 3D safety zones may also be defined by a shape (e.g., spherical, cylindrical) of the 3D safety zone.

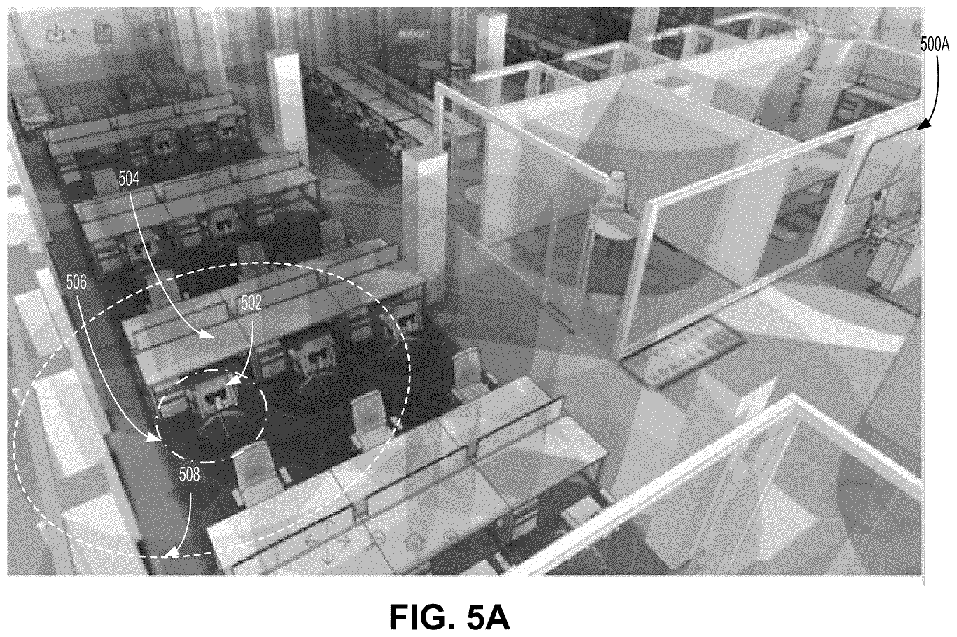

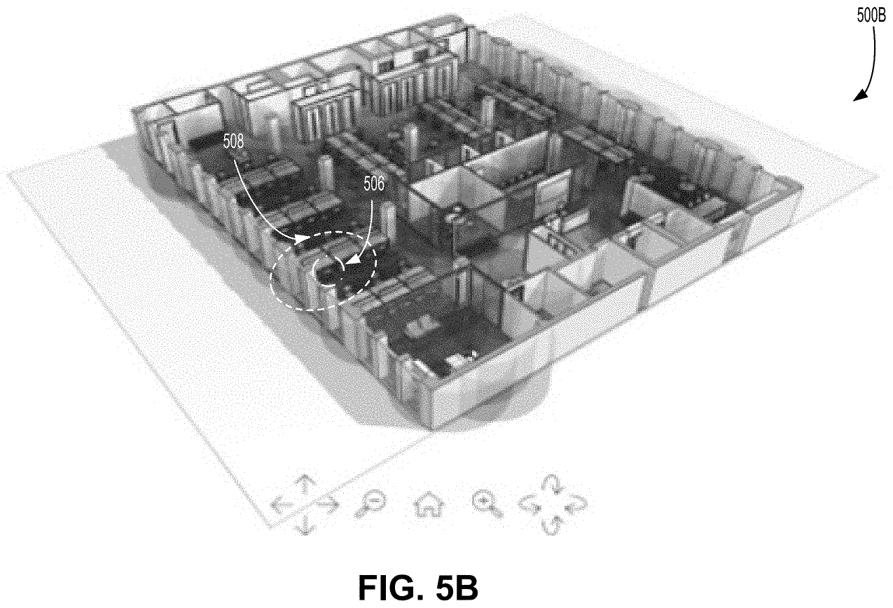

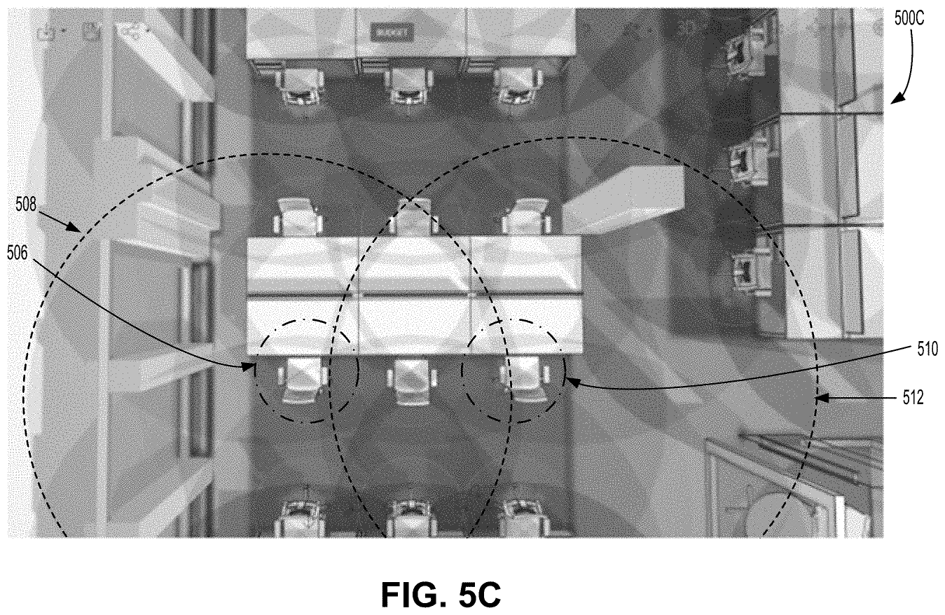

Referring now to FIG. 5A, an visual representation 500A of a 3D model representation is shown. The visual representation 500A includes the 3D object model representative of a workplace object 502, being a chair object, the 3D object model representative of a workplace object 504, being a table object, and a visual representation of the inner subzone 506 and a visual representation of the outer subzone 508.

In the shown embodiment, the inner subzone 506 is demarked by a zone having an outer dot and line perimeter. The inner subzone 506 is centered on the chair object 502, as the likely location of an individual was determined to be in a chair while in the workplace of visual representation 500A.

In the shown embodiment, the inner subzone 506 and the outer subzone 508 are demarked by separate shades and perimeters. In example embodiments, a first indicator (e.g., shade or colour) is exclusively used to indicate the whole safety zone. Any combination of indicators, with any combination of safety zone elements is contemplated.

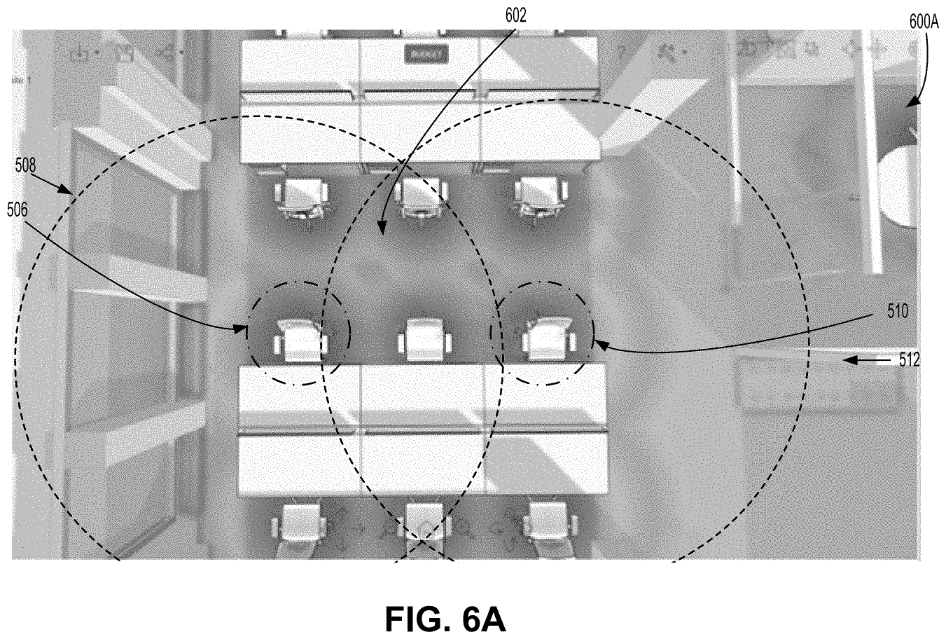

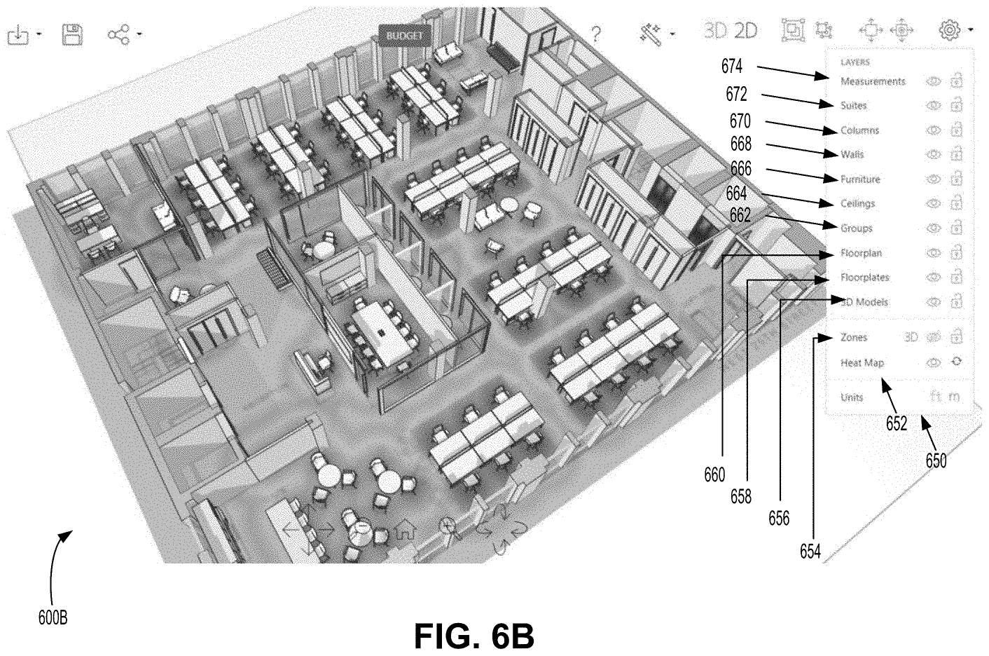

In some embodiments, the visual representation 500A may include a means of toggling one and off, or otherwise augmenting (e.g., changing colour) the various elements of the safety zones (shown in FIG. 6B).

In example embodiments, the safety zones have unique characteristics for one or more of the dimensions of the 3D model. For example, in the shown embodiment, the 3D safety zone includes the inner subzone 506 and the outer subzone 508 being cylindrical and having a consistent radius in the horizontal plane, while having a cylindrical height equal to the ceiling. In some example embodiments, the safety zones are 2D and have varying properties in each dimension. Various types and shapes of safety zone are contemplated.

The 3D modeller 206 populates the entire workplace layout with the 3D object models representative of workplace objects and the safety zones, as seen in FIG. 5B having the visual representation 500B. A fully populated 3D model representation may assist in visualizing workplace layout safety by showing interference between zones indicative of hazardous conditions.

To that end, the interference determiner 208 determines interference between at least two of the safety zones.

In example embodiments, in reference to illustrative FIG. 5C, and the visual representation 500C, the interference determiner 208 determines interference based on the inner subzone (e.g., inner subzones 506 and 510) of any one of the safety zones being coincident with or overlapping at least any outer subzone (e.g., outer subzones 508 and 512) of any other safety zone. For example, in the embodiment of FIG. 5C, both the inner safety zones 506 and 510 would be determined to have interference based on their respective outer subzones 508 and 512 projecting into one another's inner subzones.

In example embodiments, each of inner subzones and outer subzones define 3D regions (e.g., concentric cylindrical regions). In such embodiments, interference may be determined based on overlap of portions of 3D regions.

In example embodiments, interference determiner 208 determines interference upon any element of the safety zones being breached. For example, where the outer subzone 512 is impeded by any portion of an adjoining safety zone, the interference determiner 208 determines that there is interference between at least two of the safety zones. In a further non-limiting example, the interference determiner 208 may find that a safety zone is breached in some vertical planes and not in others. For example the safety zone may extend around a half wall workplace object and interfere with safety zones only above a half wall height.

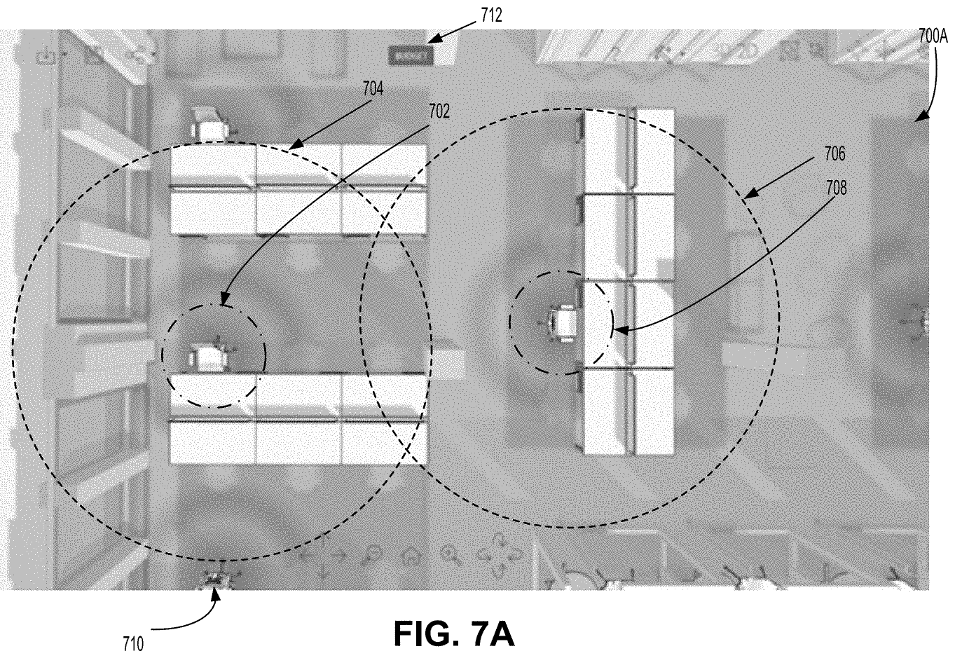

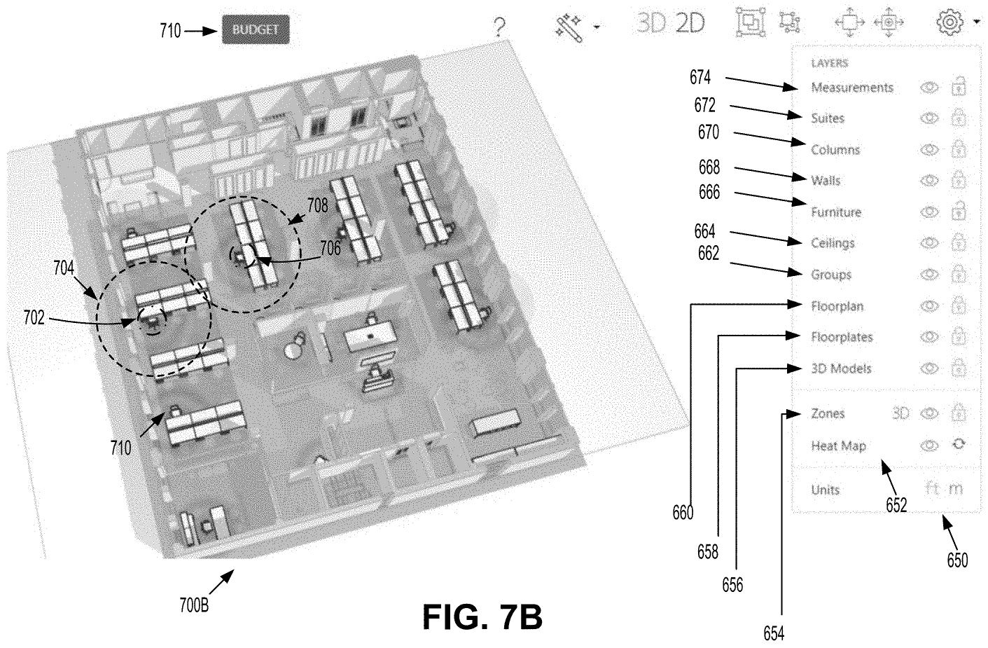

Referring now to FIGS. 6A and 6B, which show generated visual representations 600A and 600B, a second indicator (e.g., a red colour) is assigned to the safety zone(s) which experience interference. The second indicator can be any visual indicator which is separate from a first indicator (see first indicator 704 in FIG. 7A) which is indicative of a lack of interference.

In some embodiments, the second indicator replaces the first visual indicator for the at least two of the safety zones having determined interference. In further non-limiting example embodiments, the second indicator augments the first indicator, for example retaining the shape of the first indicator while changing colour.

FIG. 6A shows that, as a result of the interference between the respective inner subzones 506 and 510 and outer subzones 508 and 512, the zones are represented with a second visual indicator indicative of interference, namely a red/yellow/green/blue coloured cylinder. FIG. 6B shows that in the provided workplace, each any every one of the determined likely locations of individuals, based on identified workplace objects, experiences interference with another likely locations of individuals based on the safety zone parameters.

In example embodiments, in addition to determining whether there is interference between at least two of the safety zones, the interference determiner 208 further quantifies the amount of interference (alternatively referred to as the intensity of interference or the magnitude of interference) between the two zones. For example, the interference determiner 208 may determine that the magnitude of interference, or how much a safety zone has been breached by a second safety zone (e.g., a first safety zone extends 2 feet into a second safety zone vs the first safety zone extending 4 feet into the second safety zone).

Similar to determining whether there is interference between at least two of the safety zones, interference determiner 208 may determine the magnitude relative to any element of the safety zone. For example, the magnitude of interference may only be determined upon the inner subzone of a safety zone being breached.

The amount of interference between the two zones may be shown by augmenting any one of the first visual indicator and the second visual indicator. For example, the second visual indicator may be configured to change colour with increasing intensity to use darker shades of red colours, similar to a heat map. Alternatively, the first visual indicator may increasingly increase in transparency with increasing interference intensity, highlighting through absence the second visual indicator.

In example embodiments, only the portions of the at least two safety zones which are in interference with are represented by the second visual indicator. For example, zone 602 shown in FIG. 6A, which indicates the overlap between the respective outer subzones 512 and 508, may be the only area or volume assigned the second visual indicator.

The 3D model representation of the workplace layout may include an ability to toggle which features or models (referred to in FIG. 6B as layers) are used in the visual representation.

For example, FIG. 6B shows the interactive panel 650, which includes means to adjust the following features/models within the visual representation: the magnitude of interference switch 652, the safety zone switch 654, the 3D model switch 656, the floorplates switch 658, the floorplan switch 660, the groups switch 662, the ceiling switch 664, the furniture switch 666, the wall switch 668, the column switch 670, the suites switch 672, and the measurements switch 674.

In order, as described herein the magnitude of interference switch 652 may toggle on or off whether the visual representation indicates the intensity of interference. The safety zone switch 654 may toggle on or off whether the visual representation indicates one or more features of the safety zones. The 3D model switch 656 may toggle on or off whether the visual representation is a 3D representation, or whether a 2D model is generated using the 3D modeller 208. The floorplates switch 658 may toggle on or off whether the visual representation includes floorplate elements. The floorplan switch 660 may toggle on or off whether the visual representation includes visual elements which are extracted from the data structure, such as an initial shading shown in FIG. 3. The groups switch 662 may toggle on or off whether the visual representation includes visual elements indicative of grouping between 3D object models representative of workplace objects and/or likely locations of individuals (e.g., an accounting wing within the workplace layout). The ceiling switch 664 may toggle on or off whether the visual representation includes ceiling elements. The furniture switch 666 may toggle on or off whether the visual representation indicates the 3D object models representative of workplace objects, or any subset of workplace objects (e.g., seating workplace objects). The structural switch 668 may toggle on or off whether the visual representation indicates the 3D object models representative of workplace objects that are structural elements, or any subset of structural elements (e.g., wall elements). Similarly, the second structural switch 670 may toggle on or off whether the visual representation indicates the 3D object models representative of workplace objects that are structural elements not represented by the structural switch 668 (e.g., columns, stairs, and so forth). The suites switch 672 may toggle on or off whether the visual representation indicates enclosed spaces within the workplace layout (e.g., an area enclosed by 3 or more wall workplace objects may be removed from the visual representation to aid visualizing workplace layouts in a compartmentalized fashion). Finally, the measurements switch 674 may toggle on or off whether the visual representation includes any measurements between or inherent to workplace objects, either within the 3D model representation of the workplace layout, or received as a result of input.

Referring now to FIGS. 7A and 7B, visual representations 700A and 700B show a workplace layout where interference is not present.

In the shown embodiment of FIG. 7A, a first inner subzone 702 and first outer subzone 704 associated with a first 3D object model representative of a chair workplace object are not interfering with any other safety zone, including a second inner subzone 706 and second outer subzone 708 associated with a second 3D object model representative of a second chair workplace object.

Similarly, in the shown embodiment of FIG. 7B, where the first inner subzone 702 and the first outer subzone 704 associated with the first 3D object model representative of a chair workplace object are moved, there is no interference with any other safety zone, including the second inner subzone 706 and the second outer subzone 708 associated with the second 3D object model representative of the second chair workplace object. As a result of the movement of the first inner subzone 702 and the first outer subzone 704, a third 3D object model representative of a chair workplace object 710 has been moved to maintain a configuration which does not have interference between the safety zones.

FIGS. 7A and 7B further show a visual indicator, namely, button 712, for receiving input indicative of a request to determine a financial implication based on the 3D model representation in the visual representation. In example embodiments, the financial implication may be a cost per employee based on a lease amount and the amount of determined likely locations of individuals. In further non-limiting embodiments, the financial implication may include a cost of furniture, where, as described herein, server 102 retrieves pricing information for the identified workplace objects from the data sources 106 (e.g., furniture manufacturer, retailer, etc.) and tallies the cost of all workplace objects within the workplace layout. In yet further non-limiting embodiments, the financial implication may include a cost to change structural elements within the workplace layout (e.g., adding walls, etc.).

The visual indicator for receiving input indicative of a request to determine a financial implication may be any visual indicator, such as an entry field, a button, a switch, and so forth.

In response to receiving the input indicative of a request to determine a financial implication, the server 102 determines the financial implication based on the existing configuration of the 3D model representation. The server 102 may receive and provide varying financial implication where inputs are received which modify or update the 3D model representation (e.g., further chairs are added to the model).

In some embodiments, the server 102 populates the visual representation with a visual indicator of the determined financial implications. For example, the visual indicator of the determined financial implications may be a table, a link to a site which displays or maintains the determined financial implications, etc.

In some embodiments, the 3D modeller 206 may further identify, determine or receive input indicative of one or more mitigating workplace objects which, based on mitigating workplace object safety parameters, act on safety zones to increase required minimum separation between individuals. For example, the mitigation workplace objects may include objects that reduce or inhibit the transmission of contagions. The mitigating workplace objects may include protective equipment and personal protective equipment. For example, the 3D modeller 206 may receive input to add a 3D object model representative of a wall workplace object into the model at a mitigating workplace object location. In some embodiments, the 3D modeller 206 receives mitigating workplace objects identified by data structure processor 202, and mitigating workplace object safety parameters retrieved by the safety parameter operator 204, similar to how non-mitigating workplace objects are processed by the server 102.

In some embodiments, the 3D modeller identifies previously identified or determined workplace objects, such as structural workplace objects (e.g., a wall object, or a column object), as being a mitigating workplace objects.

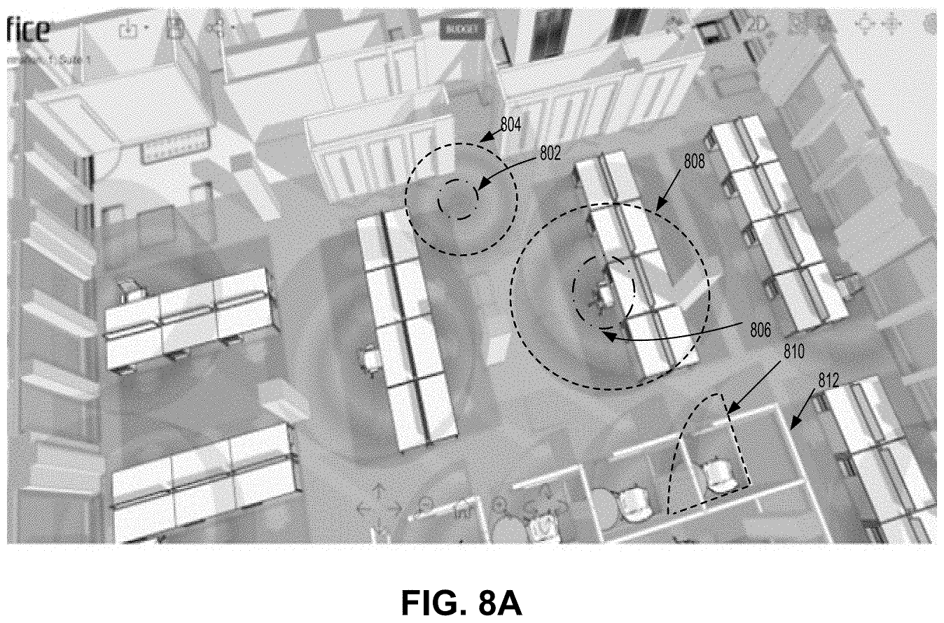

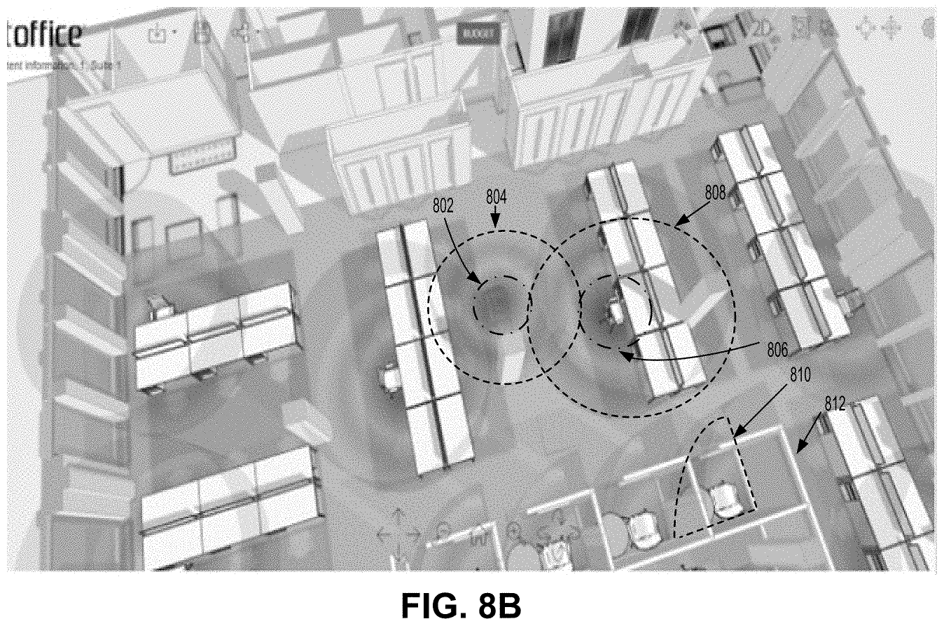

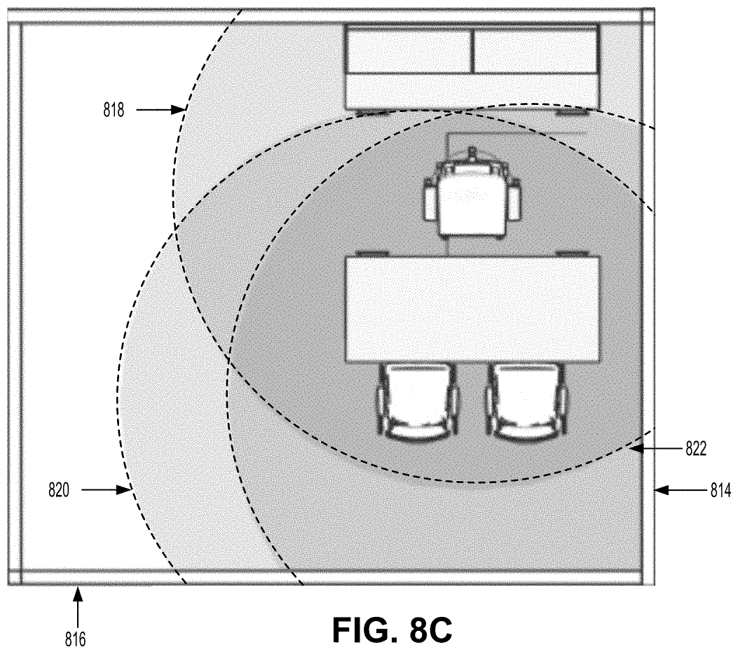

The one or more mitigating workplace objects may be assigned the mitigating safety parameters which may be indicative of a size of a mitigating safety zone. In example embodiments, the mitigating safety parameters act as modifiers to other safety parameters within the 3D model representation. For example, a 3D object model of a wall mitigating workplace object 812, as shown in FIGS. 8A and 8B, may augment or modify the safety zone 810 associated with a nearby chair workplace object model, and prevent the safety zone 810 from extending or projecting past the wall mitigating workplace object 812. In another non-limiting example, the 3D object model of a wall mitigating workplace objects 814 and 816 of FIG. 8C augment or modify the safety zones 818, 820, and 822 associated with the nearby chair workplace object models, and prevent the safety zones 818, 820, and 822 from extending or projecting past the wall mitigating workplace objects 814 and 816.

Mitigating safety parameters acting as modifiers to other safety parameters within the 3D model representation can include any deforming of the safety zone, such as changing the shape, or changing the size, uniformly or in a non-uniform manner.

Similar to the safety parameters and the safety zones, the mitigating safety parameters and the mitigating safety zones may vary based on the mitigating workplace object type (e.g., a wall provides a greater mitigating effect as compared to a half-wall or cubicle wall), the location of the mitigating workplace object type, and so forth. For example, where the wall mitigating workplace object 812 is a half wall, and the safety zone 810 is reduced, however the safety zone 810 would not be prevented (not shown), from extending above the half wall mitigating workplace object 812. Alternatively stated, the size and shape of the safety zone is changed in a non-uniform manner, where the half wall object only actions on a portion of the safety zone that is acted upon by the half wall object. Any size and any type of reduction are contemplated.

In non-limiting example embodiments, the mitigating workplace objects may be associated with likely locations of the individual. For example, the mitigating workplace object may be an N95 mask, which may reduce the safety zone of the wearer of the mask. Any size and any type of reduction based on any type of personalized or wearable mitigating workplace objects are contemplated.

In further non-limiting example embodiments, the mitigating workplace object may include a mitigating object safety zone associated with one or more workplace objects. For example, a mitigating object safety zone, where a mitigating object is an isolated HVAC system, may be defined to cover the area which includes the isolated HVAC system, as the isolated HVAC system may decrease the spread of harmful biological agents. The mitigating object safety zone may reduce the size of any safety zone which is coincident with the mitigating object safety zone.

The mitigating workplace objects may include objects which are capable of interacting with, or acting on (e.g., deforming or changing the size or shape of the safety zone), multiple safety zones simultaneously. For example, the mitigating workplace object may be an air filtration system, which may reduce the safety zone of multiple nearby safety zones.

In 3D model representations which include mitigating workplace objects, the interference determiner 208 may determine whether the mitigating workplace objects act on (e.g., deforming or changing the size or shape of the safety zone) one of the at least two safety zones which interfere, and update the one of the at least two safety zones based on the mitigating workplace object safety parameter to increase the required minimum separation between individuals of the one of the at least two safety zones. The interference determiner 208 may then determine whether there is interference between the updated at least two of the safety zones.

Updating the one of the at least two safety zones can include changing the size, shape, colouring, or any other visual feature of the safety zone based on the mitigating workplace objects or other workplace objects such as structural workplace objects.

In 3D model representations which include mitigating workplace objects, the interference determiner 208 may determine whether at least two safety zones interfere having regard to all safety zones which are updated to include the mitigating workplace object safety zones and their effects on other safety zones.

In example embodiments, the server 102 may receive input indicative of likely locations of individuals independent of the determined likely locations of individuals. For example, the server 102 may receive updated or real time location data from client devices such as the second client mobile device 104b. In example embodiments, the server 102 receives updated or real time location data from data sources 106, such as server of the operator of the workplace layout such as key card entry data. The updated location information can be received by the server 102 based on a user input or interactive panel displayed in conjunction with the visual representation.

The real time location, or the updated locations of individuals can be determined through one of the following technologies, for example: facial recognition from closed circuit camera feeds, indoor position tracking systems, proximity based systems using Bluetooth beacons, ultra wide band systems, acoustic mapping, infrared mapping, etc. A variety including any of the above technologies can be used to determine an updated or real-time location of the individuals.

In some embodiments, the type of technology used to determine the real time location, or the updated location is based on the required accuracy for the system 102.

In response to receiving updated or real time likely locations of individuals, the 3D modeller 206 may update the 3D model representation to either include new likely locations of individuals based on the updated or real time likely locations of individuals, or augment the 3D model representation to update existing likely locations of individuals with the updated likely locations of individuals. For example, the server 102 may receive real-time location from a client device 104 indicating an individual who does not have a corresponding workplace object is within the workplace layout.

Referring again to FIGS. 8A and 8B, the visual representations 800A and 800B, where an inner subzone 802 and an outer subzone 804 corresponding to a location provided by a mobile device (hereinafter referred to as a “dynamic safety zone”) moving between positions within the workplace layout is shown.

In FIG. 8A, the interference determiner 208 determines that the dynamic safety zone does not impede the nearby inner subzone 806 or the nearby outer subzone 808 (hereinafter referred to as the “nearby safety zone”). As a result, both the dynamic safety zone and the nearby safety zone are shown in the visual representations 800A with a first visual indicator for indicating a lack of interference.

In FIG. 8B, the server 102 receives updated or real time likely location data which requires the 3D modeller 206 to update the likely location of the dynamic safety zone. In the embodiment shown, the dynamic safety zone location is updated in the visual representation 800B in accordance with the received real time information, and a second visual indicator is appropriate for both the dynamic safety zone and the nearby safety zone as they interfere with one another.

Similarly, the server 102 may receive input indicative of updated workplace objects or likely locations of workplace objects. For example, the server 102 may receive an input which changes the location of a workplace object within the workplace layout.

In response to receiving updated workplace objects or likely locations of workplace objects, the 3D modeller 206 may update the 3D model representation to include the updated information.

In non-limiting example embodiments where the workplace object type is updated, for example where input is received identifying a wall is a half-wall, the safety parameter operator 204 may retrieve updated safety parameters to correspond to the updated workplace objects.

Where likely locations of workplace objects are updated (e.g., new workplace objects added to the workplace layout), the 3D modeller 206 may be configured to update (e.g., determine again) the likely locations of individuals based on the location of the workplace object. For example, the likely locations of individuals may be updated to reflect that workplace objects have been moved within the 3D model representation. Alternatively, the 3D modeller 206 may be configured to update (e.g., determine again) the likely locations of individuals based on changes to the type of workplace objects (e.g., more likely locations where a single seating chair is replaced or updated with a two seat couch).

As with the real time likely locations of individuals, the updated workplace objects may be assigned updated safety parameters by the safety parameter operator 204 upon retrieval, which the 3D modeller 206 may incorporate into an updated safety zone in the 3D model representation.

Similar to the discussion with respect to real time location information, the interference determiner 208 may update, or determine again whether there is interference between the updated safety zone and any other safety zone within the workplace layout based on updated workplace objects or likely locations of workplace objects.

In example embodiments, interference can determined based on the 3D model representation. According to some embodiments, for example, interference can determined by the interference determiner 208 based on the determined likely locations of individuals and the identified plurality workplace objects and determined respective locations of the workplace objects, independent of the process of generating a 3D model representation.

A determination of interference may trigger an alert being displayed in the visual representation which uses the 3D model representation. In example embodiments, the alert is a stop sign indicating the workplace layout configuration is not safe.

In example embodiments tracking a dynamic safety zone, alert may be generated in real time.

In example embodiments tracking a dynamic safety zone, alerts may be generated based on risk associated with traffic patterns determined over a period of time.

In example embodiments, the alert is a non-visual alert, such as a sound. Various alert types are contemplated.

As described herein, a visualizer 210 is used to generate the visual representation using the 3D model representation. The visual representation may include a first visual indicator indicative of the 3D safety zones, and a second visual indicator indicative of the determined interference between safety zones.

The visual representation may be provided directly to the client device 104 for viewing and interacting, or in some scenarios the visualizer 210 provides the client device 104 with the 3D model representation and instructions allowing for the generating of the visual representation using the 3D model representation on the client device 104.

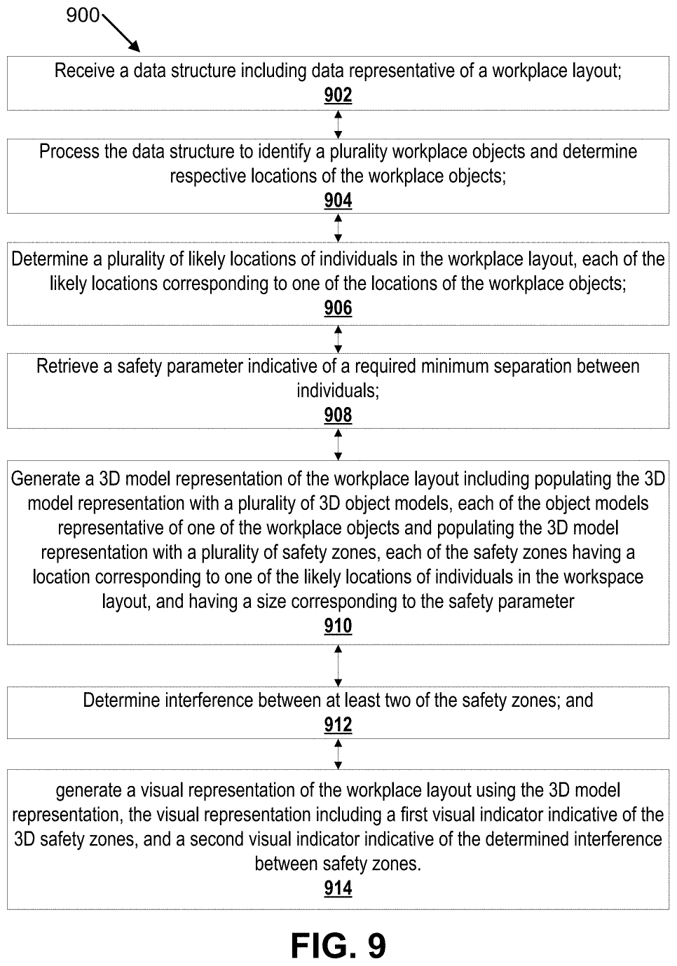

Referring now to FIG. 9, a flowchart illustrative of an example of a method 900 for visualizing workplace layout safety, in accordance with some embodiments.

At step 902, a data structure including data representative of a workplace layout is received, for example, by server 102.

At step 904, the data structure is processed (e.g., via data structure processor 202) to identify a plurality workplace objects and determine respective locations of the workplace objects.

At step 906, a plurality of likely locations of individuals in the workplace layout is determined, each of the likely locations corresponding to one of the locations of the workplace objects.

At step 908, a safety parameter indicative of a required minimum separation between individuals is received.

At step 910, a 3D model representation of the workplace layout is generated, where the 3D model representation includes populating the 3D model representation with a plurality of 3D object models, and populating the 3D model representation with a plurality of safety zones.

Each of the object models may be representative of one of the workplace objects, and each of the safety zones may have a location corresponding to one of the likely locations of individuals in the workplace layout, and having a size corresponding to the safety parameter.

Optionally, the shape of each of the safety zones may be based on whether the safety zone is acted upon by workplace objects or mitigating workplace objects. For example, a wall workplace object may augment or deform the shape of nearby safety zones, preventing them from passing through the wall workplace object.

At step 912, whether there is interference between at least two of the safety zones is determined.

In example embodiments, all of the safety zones interfere with one another, or alternatively none of the safety zones may interfere with each other.

At step 914, a visual representation of the workplace layout is generated using the 3D model representation. The visual representation includes a first visual indicator indicative of the 3D safety zones, and a second visual indicator indicative of the determined interference between safety zones.

Step 914 may, in some scenarios, include generating a visual representation which includes only one of the first visual indicator and the second visual indicator, for example in scenarios where safety zones either do not interfere with one another (e.g., FIG. 7B), or scenarios where the safety zones are all interfered with (e.g., FIG. 6B).

Where method 900 includes a single combination of steps, any and all possible combination of the disclosed steps, in any other, is contemplated. For example, step 910 may occur prior to, or simultaneously with step 912. For further clarification, if one embodiment comprises steps A, B, and C, and a second embodiment comprises elements B and D, then the application is also considered to include other remaining combinations of A, B, C, or D, even if not explicitly disclosed.

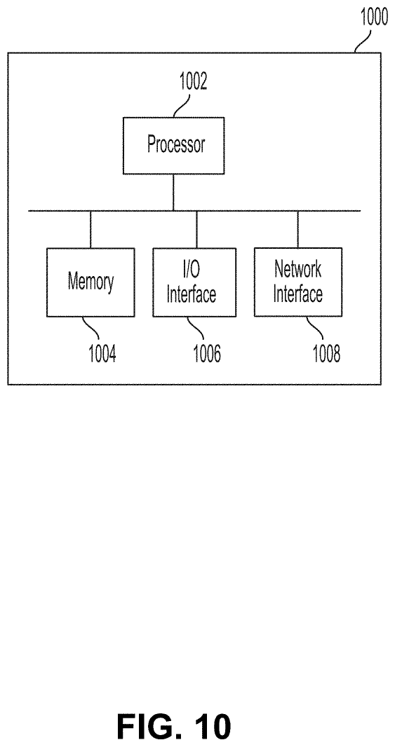

FIG. 10 is a schematic diagram of computing device 1000 which may be used to implement server 102, in accordance with an embodiment.

As depicted, computing device 1000 includes at least one processor 1002, memory 1004, at least one I/O interface 1006, and at least one network interface 1008.

Each processor 1002 may be, for example, any type of microprocessor or microcontroller (e.g., a special-purpose microprocessor or microcontroller), a digital signal processing (DSP) processor, an integrated circuit, a field programmable gate array (FPGA), a reconfigurable processor, a programmable read-only memory (PROM), or any combination thereof.

Memory 1004 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 1006 enables computing device 1000 to interconnect with one or more input devices, such as a keyboard, mouse, camera, touch screen and a microphone, or with one or more output devices such as a display screen and a speaker.

Each network interface 1008 enables computing device 1000 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

For simplicity only, one computing device 1000 is shown but server 102 may include multiple computing devices 1000. The computing devices 1000 may be the same or different types of devices. The computing devices 1000 may be connected in various ways including directly coupled, indirectly coupled via a network, and distributed over a wide geographic area and connected via a network (which may be referred to as “cloud computing”).

For example, and without limitation, a computing device 1000 may be a server, network appliance, set-top box, embedded device, computer expansion module, personal computer, laptop, personal data assistant, cellular telephone, smartphone device, UMPC tablets, video display terminal, gaming console, or any other computing device capable of being configured to carry out the methods described herein.

In some embodiments, a computing device 1000 may function as a client device 104, or data source 106.

In some embodiments, each of the data structure processor 202, the safety parameter operator 204, the 3D Modeller 206, the interference determiner 208, and the visualizer 210 are a separate computing device 1000. In some embodiments, the data structure processor 202, the safety parameter operator 204, the 3D Modeller 206, the interference determiner 208, and the visualizer 210 are operated by a single computing device 1000 having a separate integrated circuit for each of the said components. Any combination of software and hardware implementation of the data structure processor 202, the safety parameter operator 204, the 3D Modeller 206, the interference determiner 208, and the visualizer 210 is contemplated. In some embodiments, all or parts of data structure processor 202, the safety parameter operator 204, the 3D Modeller 206, the interference determiner 208, and the visualizer 210 may be implemented using conventional programming languages such as Java, J#, C, C++, C#, Perl, Visual Basic, Ruby, Scala, etc. In some embodiments, these components of system 100 may be in the form of one or more executable programs, scripts, routines, statically/dynamically linkable libraries, or the like.

The foregoing discussion provides many example embodiments of the example subject matter. Although each embodiment represents a single combination of elements, the subject matter is considered to include all possible combinations of the disclosed elements. Thus if one embodiment comprises elements A, B, and C, and a second embodiment comprises elements B and D, then the subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Of course, the above described embodiments are intended to be illustrative only and in no way limiting. The described embodiments are susceptible to many modifications of form, arrangement of parts, details and order of operation. The disclosure is intended to encompass all such modification within its scope, as defined by the claims.

What is claimed is:

1. A computer-implemented method for visualizing workplace layout safety, the method comprising:
receiving a data structure including data representative of a workplace layout;
processing the data structure to identify a plurality workplace objects and determine respective locations of the workplace objects;
determining a plurality of likely locations of individuals in the workplace layout, each of the likely locations corresponding to one of the locations of the workplace objects;
retrieving a safety parameter indicative of a required minimum separation between individuals;
generating a 3D model representation of the workplace layout, the generating including:
populating the 3D model representation with a plurality of 3D object models, each of the object models representative of one of the workplace objects;
populating the 3D model representation with a plurality of safety zones, each of the safety zones having a location corresponding to one of the likely locations of individuals in the workplace layout, and having a size corresponding to the safety parameter;
determining interference between at least two of the safety zones; and
generating a visual representation of the workplace layout using the 3D model representation, the visual representation including a first visual indicator indicative of the safety zones, and a second visual indicator indicative of the determined interference between safety zones.

2. The method of claim 1, wherein the plurality of safety zones each include:
an outer subzone, having a size corresponding to the safety parameter; and
an inner subzone, having a size corresponding to a space one of the individuals is expected to occupy in the workplace layout.

3. The method of claim 2, wherein said determining the interference includes determining whether the outer subzone of one of the at least two of the safety zones interferes with the inner subzone of the other of the at least two of the safety zones.

4. The method of claim 1, further comprising:
receiving input indicative of one or more mitigating workplace objects at one or more respective mitigating workplace locations within the workplace layout.

5. The method of claim 4, further comprising:
retrieving a mitigating workplace object safety parameter indicative of a increased required minimum separation between individuals.

6. The method of claim 4, wherein said generating the 3D model representation of the workplace layout includes:
populating the 3D model representation with a plurality of 3D mitigating workplace object models, each of the mitigating workplace object models representative of one of the mitigating workplace workplace objects;
updating the 3D model representation having the plurality of safety zones based on whether the mitigating workplace objects acts on at least one of the safety zones to deform at least one of the safety zones.

7. The method of claim 6, wherein said determining the interference includes determining interference between the at least two of the safety zones of the updated 3D model representation.

8. The method of claim 6, wherein said deforming includes at least one of changing a shape of the safety zone and changing a size of the safety zone.

9. The method of claim 1, further comprising:
receiving an updated likely location of an individual; and
updating the 3D model representation to include an updated safety zone incorporating the updated likely locations of the individuals.

10. The method of claim 9, wherein said determining the interference includes determining whether there is interference with the updated safety zone.

11. A computer-implemented system for visualizing workplace layout safety comprising:
at least one processor;
memory in communication with the at least one processor; and
software code stored in the memory,
the software code when executed at the at least one processor causes the system to:
receive a data structure including data representative of a workplace layout;
process the data structure to identify a plurality workplace objects and determine respective locations of the workplace objects;
determine a plurality of likely locations of individuals in the workplace layout, each of the likely locations corresponding to one of the locations of the workplace objects;
receive a safety parameter indicative of a required minimum separation between individuals;
generate a 3D model representation of the workplace layout by:
populating the 3D model representation with a plurality of 3D object models, each of the object models representative of one of the workplace objects;
populating the 3D model representation with a plurality of safety zones, each of the safety zones having a location corresponding to one of the likely locations of individuals in the workplace layout, and having a size corresponding to the safety parameter;
determine interference between at least two of the safety zones; and
generate a visual representation of the workplace layout using the 3D model representation, the visual representation including a first visual indicator indicative of the safety zones, and a second visual indicator indicative of the determined interference between safety zones.

12. The computer-implemented system of claim 11, wherein the plurality of safety zones each include:
an outer subzone, having a size corresponding to the safety parameter; and
an inner subzone, having a size corresponding to a space one of the individuals is expected to occupy in the workplace layout.

13. The computer-implemented system of claim 12, wherein said determining the interference includes: determining whether the outer subzone of one of the at least two of the safety zones interferes with the inner subzone of the other of the at least two of the safety zones.

14. The computer-implemented system of claim 12, wherein the processor is further configured to:
receive input indicative of one or more mitigating workplace objects at one or more respective mitigating workplace locations within the workplace layout.

15. The computer-implemented system of claim 14, wherein the processor is further configured to:
receive a mitigating workplace object safety parameter indicative of a increased required minimum separation between individuals.

16. The computer-implemented system of claim 14, wherein said generating the 3D model representation of the workplace layout includes:
populating the 3D model representation with a plurality of 3D mitigating workplace object models, each of the mitigating workplace object models representative of one of the mitigating workplace objects; and
updating the 3D model representation having the plurality of safety zones based on whether the mitigating workplace objects acts on one or more safety zones to deform at least one of the safety zone.

17. The computer-implemented system of claim 16, wherein said determining the interference between at least two of the safety zones further includes:
determining interference between the at least two of the safety zones of the updated 3D model representation.

18. The computer-implemented system of claim 16, wherein said deforming the at least one safety zone comprises one or more of changing a shape of the safety zone and changing the size of the safety zone.

19. The computer-implemented system of claim 11, wherein the processor is further configured to:
receive an updated likely location of an individual; and
update the 3D model representation to include an updated safety zone incorporating the updated likely locations of the individuals.

20. The computer-implemented system of claim 19, wherein said determining said interference includes determining whether there is interference with the updated safety zone.

21. A non-transitory computer-readable medium having stored thereon machine interpretable instructions which, when executed by a processor, cause the processor to perform a computer-implemented method for visualizing workplace layout safety, the method comprising:
receiving a data structure including data representative of a workplace layout;
processing the data structure to identify a plurality workplace objects and determine respective locations of the workplace objects;
determining a plurality of likely locations of individuals in the workplace layout, each of the likely locations corresponding to one of the locations of the workplace objects;
receiving a safety parameter indicative of a required minimum separation between individuals;
generating a 3D model representation of the workplace layout, the generating including:
populating the 3D model representation with a plurality of 3D object models, each of the object models representative of one of the workplace objects;
populating the 3D model representation with a plurality of safety zones, each of the safety zones having a location corresponding to one of the likely locations of individuals in the workplace layout, and having a size corresponding to the safety parameter;
determining interference between at least two of the safety zones; and
generating a visual representation of the workplace layout using the 3D model representation, the visual representation including a first visual indicator indicative of the safety zones, and a second visual indicator indicative of the determined interference between safety zones.
